(19) United States
(12) Patent Application Publication
(10) Pub. No.: US 2010/0180648 A1
(43) Pub. Date: Jul. 22, 2010

(54) SECURITY ATTACHMENT AND METHOD FOR USE WITH A SECURITY SLOT, E.G. IN A LAPTOP COMPUTER

(76) Inventor: Stefan Knox, West Sussex (GB)

Correspondence Address: FAY SHARPE LLP, 1228 Euclid Avenue, 5th Floor, The Halle Building, Cleveland, OH, 44115, US

(21) Appl. No.: 12/675,586

(22) PCT Filed: Aug. 29, 2008
(86) PCT No.: PCT/GB2008/050762

§ 371 Date: Feb. 26, 2010

Related U.S. Application Data
(60) Provisional application No. 60/985,712, filed on Nov. 6, 2007.

(30) Foreign Application Priority Data
Aug. 30, 2007 (GB) 0716879.2
Feb. 12, 2008 (GB) 0802558.7

(51) Int. Cl. E05B 73/00

(52) U.S. Cl. 70/58

(57) ABSTRACT

A security attachment for engagement in a security slot (1100) in the casing of a laptop computer or the like provides a body (1) with a rotatable lock (10) and a projecting tongue (20) which is axially retractable into a flat sided, rotatable outer casing (2). A pair of spring steel strips (40, 50; 100, 110) are slidably mounted in an elongate cavity (22) in the tongue. The tongue is inserted into the security slot by pushing the lock into the casing, and then locked in place by rotating the lock so as to advance the strips axially through the security slot within the tongue. The distal ends (42, 52; 102, 112) of the strips are deflected progressively outwardly via lateral apertures (23, 24) at the distal end (27) of the tongue by sliding engagement with a wedge (28, 29) formed at the distal end of the tongue so that they engage the laptop casing at the periphery of the aperture at an oblique angle.

This invention relates to security attachments which are adapted to engage in a small security aperture, typically but not necessarily a slot, provided on valuable portable items such as laptop computers, so as to secure the item against theft by means of a cable or alarm or the like.

Laptop computers and other valuable portable items are often provided with a security slot, typically presenting a 7 mm×3 mm, generally rectangular (i.e. rectangular or lozenge shaped) opening in the laptop casing, to receive a specially adapted security attachment. For convenience, such attachments are preferably releasable from the slot as a complete assembly by operation of a key or combination lock, an electronic locking mechanism, or the like. Typically, the attachment will include a steel cable or the like which can be secured to a fixed object to protect the laptop against theft. Alternatively, the attachment may provide an alarm which is triggered by removal or disturbance of the attachment. Less conveniently, the attachment may comprise a simple mechanical arrangement providing an anchor point which is attached to the protected item and then secured against disassembly, for example, by attachment of a separate cable or padlock.

Although the 7 mm×3 mm dimensions of such security slots are regarded by at least some manufacturers as a standard, in practice these dimensions, as well as the thickness (depth) of the outer wall of the item casing (often including an internal steel reinforcement plate) in which the slot is formed, and the depth of the available space behind the slot, are found to vary between the manufacturers of such items and between products. Apertures of other shapes may also be provided.

Much effort has been directed to the problem of fixing the attachment securely to so small a slot.

WO96/15347 discloses a security attachment having a spindle with a T-shaped cross bar at its distal end. The spindle is rotatably mounted on a lock housing from which two fixed pins project, one on either side of the spindle. In use, the cross bar is aligned with the pins and then inserted through the security slot into the space behind the slot. The spindle is then rotated to misalign the cross bar with the slot. A corresponding product is commercially available from Kensington Computer Products Group of California, USA.

Disadvantageously, this arrangement concentrates any force applied to the security attachment in the very small footprint of the cross-bar. This makes it easier to remove the attachment by wrenching, particularly if it is inserted into a slot which is larger than the exact dimensions for which it is designed. In order to mitigate this vulnerability, the product provides a rounded casing to which the cable is attached and which is rotatable about the axis of the lock and the spindle.

Moreover, if the outer wall of the protected item is relatively thin, the attachment will hang loosely from the slot at the end of its spindle, which creates an appearance of vulnerability which may invite attack. A small rubber collar arranged around the spindle and extending for a few millimetres from the body of the attachment provides a resilient buffer which mitigates a slight degree of looseness. However, it is difficult to make such a collar long enough to compensate for the full range of variation in wall thickness which is encountered in practice, without the collar forming an obstruction which would make it difficult to abut the device against the item wall so as to attach it to a full depth slot.

In order to compensate for larger variations in wall thickness, the Ezolution™ locking device available from PC Guardian Anti-Theft Products, Inc. of California, USA is provided with interchangeable spacers which may be positioned between the attachment and the protected item. The removable spacers provide incremental adjustment, and might also be used to provide a limited degree of variation (e.g. colour coding) in the appearance of the product. However, the unused spacers are easily mislaid. Security attachments typically comprise assemblies of small, intricate functional components, which makes it difficult and expensive to vary the appearance of the product and hence limits the ability of the manufacturer to respond to consumer demand in a very design conscious market.

U.S. Pat. No. 6,257,029 B1 discloses a security attachment having two locking leaves pivotably mounted on pins at the distal end of a tongue. The tongue is inserted through the security slot with the leaves folded together, and the leaves are then urged apart by means of a pushbutton so that they open out behind the wall of the protected item. A control button is pivotably mounted on one side of the square casing for retaining the pushbutton in the depressed position, after which a cable or padlock may be inserted through aligned apertures to secure the attachment.

Since the pins must pass through the security slot, they are necessarily of very small dimensions, and may therefore form points of weakness. The square casing may also be vulnerable to wrenching.

WO 96/24736 proposes various fixing arrangements comprising two legs with hook-like flanges on their distal ends, which are inserted through the security slot and then forced apart, such as by means of a wedge inserted between them, so that the flanges extend behind the outer wall.

In such arrangements, the maximum length of the leaves or flanges is restricted by the configuration of the attachment in a first insertion step, in which the leaves or flanges must pass through the security slot until they are fully received within the limited space behind. Once behind the slot, the leaves or flanges are then rotated or extended laterally in a second step to bring them into the locked position. The length of the leaves or flanges determines their footprint and hence the security of the attachment in the locked position.

WO00/79142 discloses a two-part security attachment comprising a bar with a flange at its distal end, which is received in a separate body which provides an anchor point for a cable. The bar is inserted at an angle through the security slot and then coupled to the body using a screw so that the casing of the item is clamped between the flange and the body. The attachment is fixed permanently or semi-permanently to the protected item, so that it disadvantageously protrudes from the protected item when the cable is disconnected.

WO2006/058321 proposes the use of an elastomeric element which is inserted through the security slot and then compressed so as to expand it behind the front wall. This advantageously enables the security attachment to engage the entire periphery of the slot.

However, it is found in practice that the shear strength of the elastomer may be too low to provide a secure fixing, so that such expanding elements may also be removed by wrenching, which tends to damage the elastomeric element rather than the casing of the protected item. A non-compressible hard material such as steel therefore provides a more secure attachment.

It is an object of the present invention to provide a security attachment for engagement in a security aperture, which addresses at least some of the above mentioned difficulties. It is a further object to provide a corresponding method of attachment.

Accordingly in its various aspects the invention provides a security attachment and method as defined in the claims.

Various illustrative embodiments will now be described, purely by way of example and without limitation to the scope of the claims, and with reference to the accompanying drawings, in which:

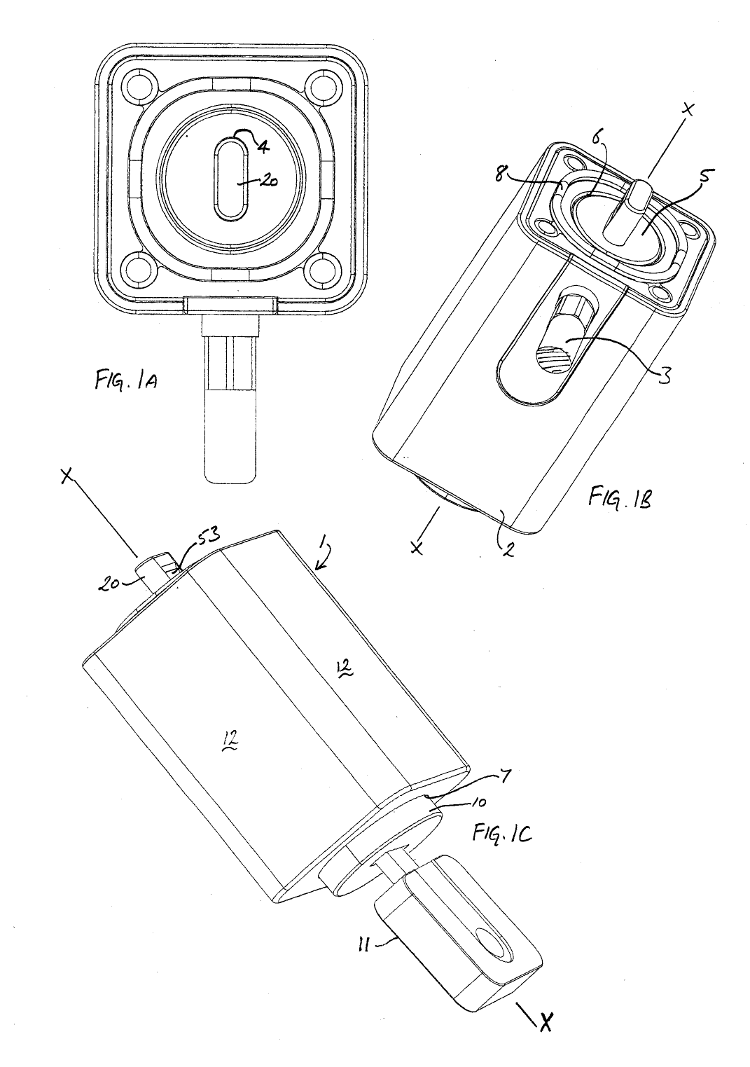

FIGS. 1A-1C show a first security attachment in the first configuration (retaining elements retracted);

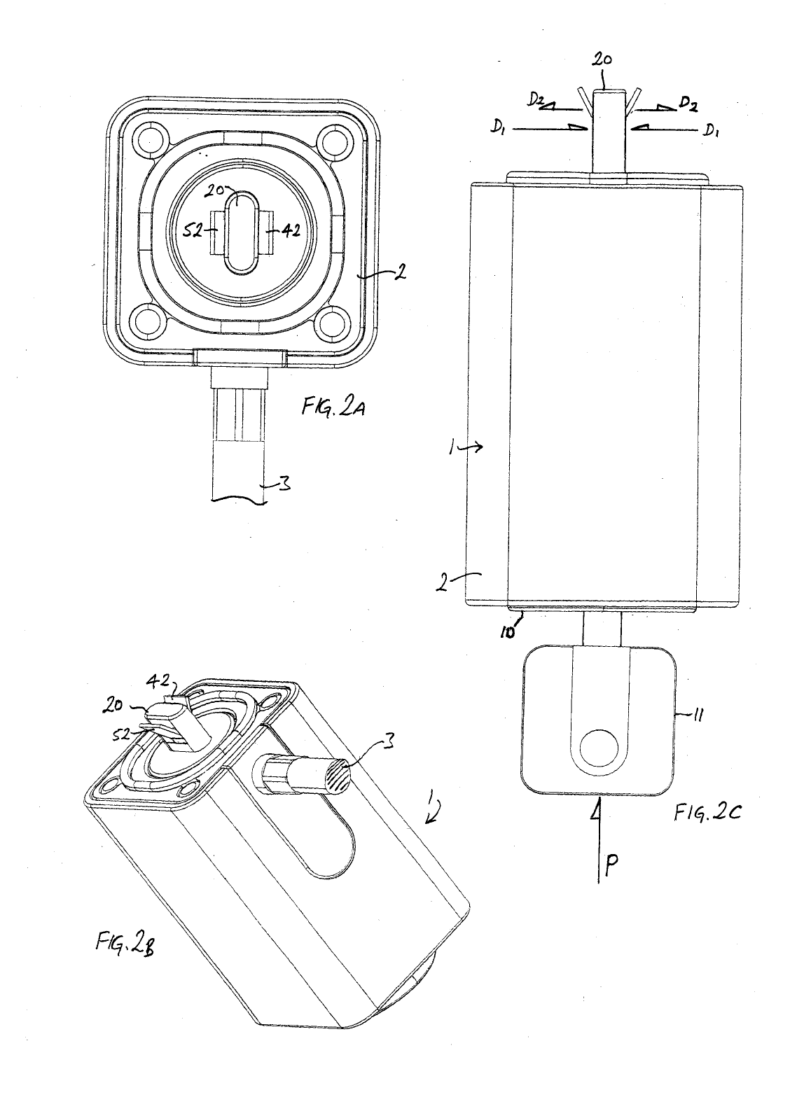

FIGS. 2A-2C show the first security attachment in the second configuration (retaining elements extended), with FIG. 2C showing the lock retracted into the outer casing and the tongue fully extended;

FIG. 3 shows a security aperture in a wall of an item;

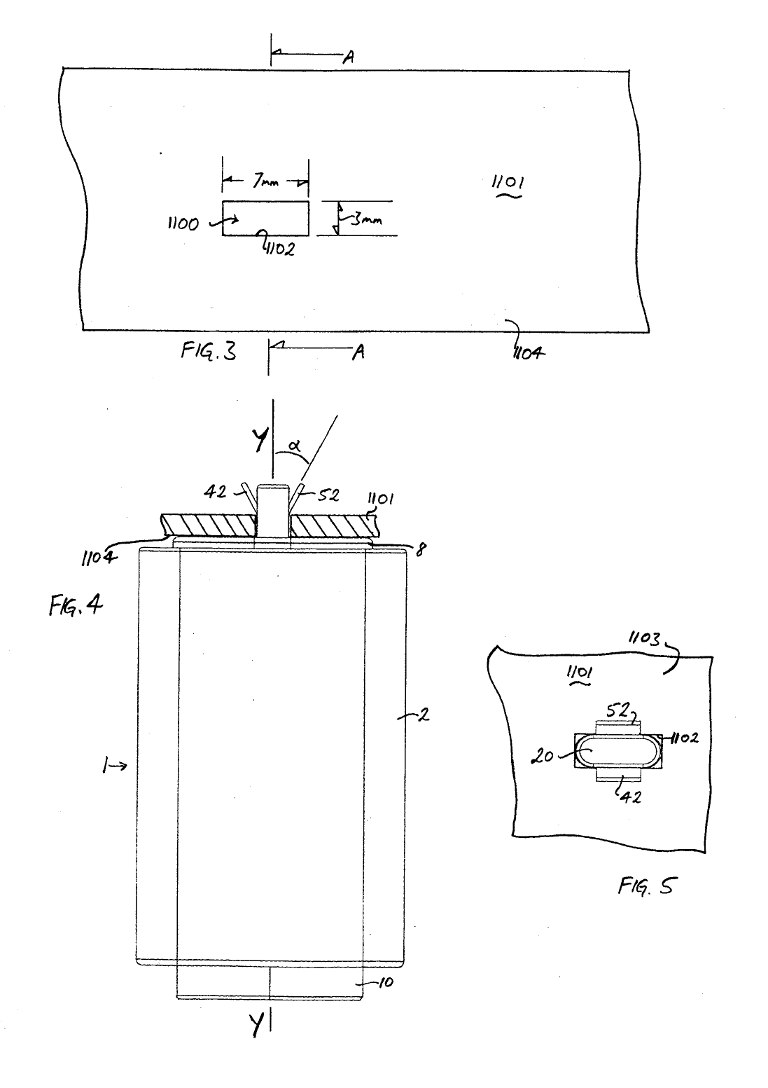

FIG. 4 is a sectional view at A-A of FIG. 3, showing the first security attachment locked in position;

FIG. 5 is a scrap view corresponding to FIG. 4, seen from the reverse side of the wall of the item;

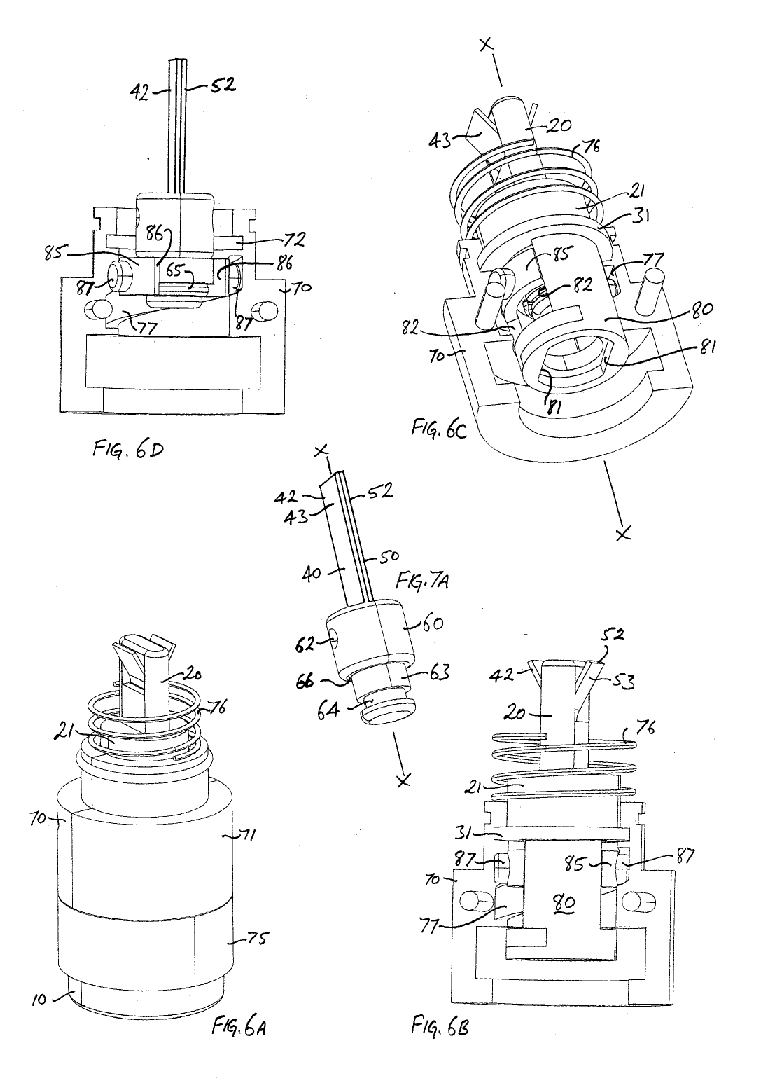

FIGS. 6A-6D show the first security attachment partially dismantled, with its various internal components in their assembled positions;

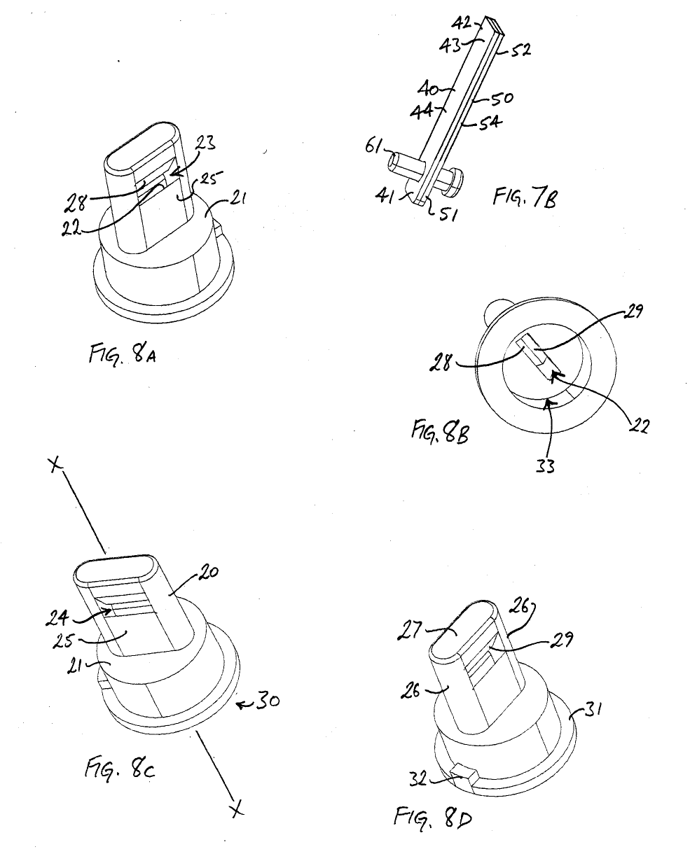

FIG. 7A shows the retaining elements of the first security attachment mounted in the anchor element;

FIG. 7B shows the retaining elements removed from the anchor element;

FIGS. 8A-8D show the tongue of the first security attachment;

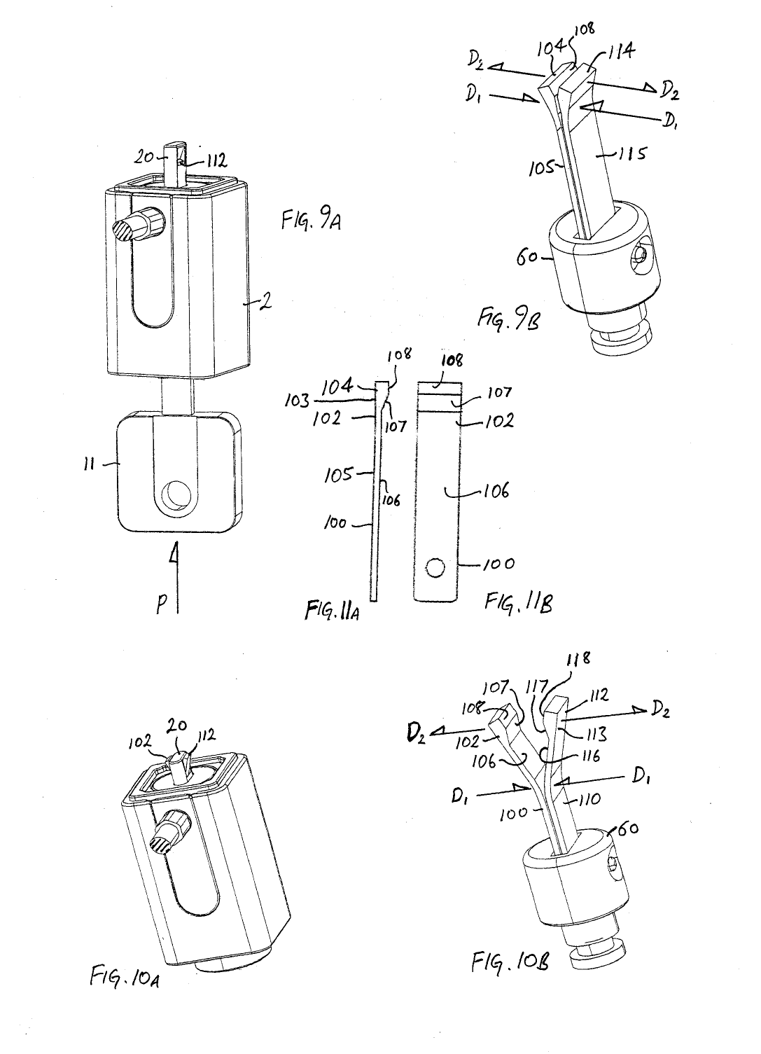

FIG. 9A shows a second security attachment in the first configuration (retaining elements retracted), showing the lock retracted into the outer casing and the tongue fully extended;

FIG. 9B illustrates the stressed position adopted by the retaining elements of FIG. 9A when the second security attachment is in the first configuration;

FIG. 10A shows the second security attachment in the second configuration (retaining elements extended);

FIG. 10B illustrates the stressed position adopted by the retaining elements of FIG. 10A when the second security attachment is in the second configuration;

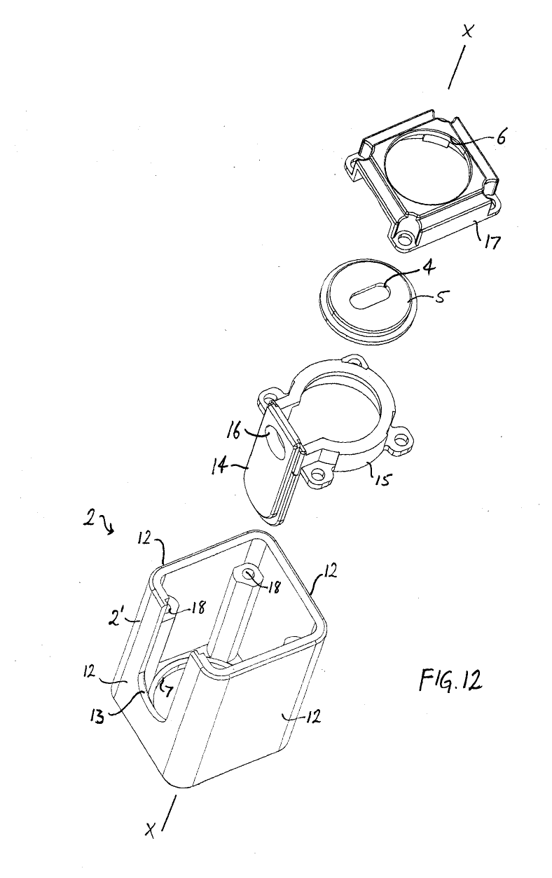

FIGS. 11A and 11B are front and side views of one retaining element of the second security attachment in an unstressed (dismantled) condition; and

FIG. 12 is an exploded view of the principal components of the outer casing of the second security attachment.

Corresponding parts are indicated by the same reference numerals in each of the figures.

Referring to FIGS. 1A-1C, a first security attachment has a body 1 with an interchangeable, metal or plastics outer casing 2 to which a flexible tether such as a steel cable 3 is attached. A guide or tongue 20 extends slidingly through a slot 4 in a circular end plate 5 which is rotatably mounted in a circular aperture 6 in a first axial end of the outer casing 2, and a lock barrel 10 extends through a second circular aperture 7 in the second axial end of the casing 2. The casing 2 together with the cable 3 rotate freely around the tongue 20 and plate 5 and the lock barrel 10, so that the casing cannot be used to apply torque to the tongue 20 so as to defeat the attachment when it is locked in position in a security aperture.

Referring also to FIG. 12, the main shell 2′ of the outer casing 2 is preferably a polyhedron, and more preferably is generally parallelepipedal with a generally square cross-section as shown, or alternatively with a generally rectangular cross-section, defining a plurality of flat sides 12 arranged between its axial ends around its longitudinal axis of rotation X. The shell 2′ can be a unitary metal part or plastics moulding, and its flat sides are compatible with conventional printing processes so that they can be printed with a variety of indicia, allowing the manufacturer easily to vary the appearance of the product by interchanging the shell as required. This makes it possible to target the product at different market sectors (for example, for use in securing different brands of laptop computer), each of which demands a different appearance.

A cut-out 13 is formed in one of the sides of the shell 2′, which receives a flat plate 14 with an integral collar 15, which together form an attachment portion to which the cable 3 is fixed by means of a swaged terminal which is captured in a hole 16 in the flat plate 14. The rotatable end plate 5 is captured axially between the collar 15 and an upper retainer 17, which are fastened to the casing 2 by means of four screws received respectively in four bores 18 arranged in the corners of the casing. The cable is thus rotatable together with the outer casing with respect to the tongue 20 about the axis X, with the attachment portion transferring any load from the cable via the casing to the tongue, so that the cable and, in particular, the flat sides of the casing (which provide surfaces which could be engaged by a wrench or the like) cannot be used to apply torque to the tongue so as to wrench it out of the security aperture.

The tongue 20 has a generally rectangular (i.e. rectangular or lozenge shaped) profile, best seen in end view in FIG. 1A, and is approximately 7 mm in width and 3 mm in thickness so that it conforms to the generally rectangular profile of a standard 7 mm×3 mm security slot, and is permanently attached to the body 1. It is axially retractable for part of its length into the outer casing 2 and biased to the fully retracted position as shown in FIGS. 1A-1C by an internal spring 76 (FIG. 6A), further described below. The lock barrel 10 is axially fixed with respect to the tongue 20 and so is also axially retractable into the outer casing, and is normally locked in rotation relative to the tongue but is rotatable relative to the tongue about the longitudinal axis X of the body by means of a removable key 11. An elastomeric cushion 8 extends axially outwardly from the end face of the casing 2 around the plate 5.

Referring also to FIGS. 8A-8D, the guide 20 is formed as an elongate tongue or bar, made for example from a metal such as steel, titanium or aluminium alloy, which extends slidingly through the slot 4 from an integral base portion 21 which is hidden beneath the plate 5. The tongue is hollow so that it defines an elongate cavity 22 with a rectangular cross section, terminating in a pair of oppositely directed apertures 23, 24 which open laterally in its wide side walls 25.

The narrow side walls 26 of the tongue 20 extend axially to support a distal end portion 27 which is shaped to form a wedge which faces the distal end of the cavity 22, defining a pair of deflection surfaces 28, 29 which converge towards the body 1 and towards the centre of the cavity 22 and obliquely to the longitudinal axis X of the body.

The base portion 21 terminates at its proximal end 30 in a flange 31 with a lug 32, and defines a cylindrical cavity 33 which is axially aligned with the longitudinal axis X of the body and communicates with the elongate cavity 22.

Referring also to FIGS. 7A and 7B, a pair of retaining elements 40, 50 are arranged back-to-back and fixed at their proximal ends 41, 51 in an anchor element 60 by means of a screw or rivet 61 which passes through holes in the respective retaining elements via a corresponding bore 62 in the anchor element. In its rest condition as shown, and prior to assembly into the tongue, each retaining element 40, 50 comprises a generally straight, flat, elongate strip of flexible, resilient, non-compressible material, preferably a metal such as spring steel. The generally flat, outer side face of the first or distal end portion 42, 52 of each respective retaining element 40, 50 defines an engagement surface 43, 53 which is aligned with the respective second or proximal portion 44, 54 and which functions in use to retain the retaining elements and the tongue in a security aperture as further described below.

In the embodiment illustrated, the proximal portions 44, 54 of the retaining elements are parallel and aligned with the longitudinal axis X of the body 1 in both the first and the second configuration, while each distal end portion 42, 52 is integral with its respective proximal portion 44, 54 and aligned with the proximal portion so that it lies parallel with the longitudinal axis X of the body in the first configuration. In alternative embodiments, the distal end portions may be permanently bent slightly outwardly in the rest condition at an oblique angle away from the longitudinal axis X of the body.

The anchor element 60 is slidingly received in the cavity 33 in the base portion 21 of the tongue 20 so that the retaining elements 40, 50 are slidingly received in the cavity 22 with their distal ends aligned with the lateral apertures 23, 24. The retaining elements thus prevent the anchor element from rotating relative to the tongue. The anchor element 60 and retaining elements 40, 50 slide together axially (parallel with the longitudinal axis X of the body) in translation in the respective cavities 33, 22 relative to the tongue 20 to define a first configuration and a second configuration.

Referring also to FIGS. 3-5, the attachment is adapted to engage in a security aperture 1100 provided in an exterior wall (typically part of the casing) 1101 of a valuable item (for example, a laptop computer). In the illustrated example, the aperture 1100 is a 7 mm×3 mm standard rectangular security slot defined by a periphery 1102, and extends through the exterior wall 1101 of the item along a first axis Y generally normal to the wall 1101, and the tongue 20 has a cross sectional profile of similar shape and dimensions.

In the first configuration, the retaining elements 40, 50 and anchor element 60 are retracted towards the body 1 so that their distal end portions 42, 52 are entirely received within the cavity 22 and lateral apertures 23, 24 in the tongue 20, as shown in FIGS. 1A-1C. In this position, the retaining elements are contained within the cross-sectional area or footprint of the tongue 20 so that the tongue together with the distal end portions of the retaining elements can be simultaneously inserted axially into or removed axially from the security aperture 1100 by aligning the longitudinal axis X of the body with the first axis Y.

With the attachment in the first configuration, and having first attached the steel cable 3 (by means of a loop in the cable through which the body of the attachment is passed, or any other convenient means) to a fixed point to which the valuable item is to be secured, the user inserts the key 11 into the lock barrel 10 and then inserts the tongue 20 axially into the aperture 1100 along the first axis Y. Once the elastomeric cushion 8 contacts the wall 1101 of the item, the user continues to push the key 11 and lock barrel 10 towards the item wall 1101, which pushes the lock barrel 10 into the casing 2 and extends the tongue 20 further into the aperture 1100 against the restoring force of the internal spring 76. The extended position of the tongue is illustrated in FIG. 2C and (in a second security attachment) in FIG. 9A, with the axial pressure applied by the user against the key 11 being indicated in each case by an arrow P.

Referring also to FIGS. 2A-2C, once the tongue 20 is fully extended into the aperture 1100, the user rotates the key 11 relative to the tongue about an axis generally aligned with (i.e. lying on or generally parallel with) the longitudinal axis X of the body, which in turn is aligned with the first axis Y of the slot. Since the tongue is not rotatable in the slot, it reacts the torque applied to the key against the periphery 1102 of the slot, which makes it convenient for the user to rotate the key.

The rotation of the key 11 configures the attachment to the second configuration by slidingly extending the anchor element 60 and retaining elements 40, 50 in translation parallel with the first axis Y of the slot relative to the tongue 20. As the key rotates, the retaining elements are advanced within the tongue 20 through the aperture 1100 in parallel with the first axis Y, and their distal end portions 42, 52 are advanced axially towards the wedge shaped distal end portion 27 of the tongue 20. As the distal end portions 42, 52 pass in translation through the bend zones defined between each of the deflection surfaces 28, 29 and the respective internal wall of the cavity 22, they are progressively resiliently bent apart and deflected (i.e. turned or angled) obliquely outwardly away from the tongue by sliding abutment with the deflection surfaces 28, 29.

As the key is rotated, the distal end portions 42, 52 are thus progressively extended outwardly from the lateral apertures 23, 24 of the tongue 20 at an oblique angle a relative to the first axis Y of the slot and relative to their respective proximal portions 44, 54 until the attachment is in the second (locked) configuration.

In the second configuration, the engagement surfaces 43, 53 extend laterally beyond the periphery 1102 of the aperture behind the wall 1101 of the item so as to engage the inner face 1103 of the wall 1101 at the periphery 1102 of the aperture and so retain the tongue and the retaining elements together in the aperture. At the same time, the proximal portions 44, 54 of the retaining elements are retained generally in parallel with the first axis Y by sliding abutment with the internal walls of the cavity 22 in the tongue 20, each of which provides a restraining force in an inward direction D₁ while each of the deflection surfaces 28, 29 of the wedge generates an expanding force in the opposite, outward direction D₂ (FIG. 2C). This combination of inward and outward forces D₁, D₂ generated by the bend zone maximises the angle of deflection a and hence ensures a secure attachment, even in security slots having non-standard dimensions.

In the embodiments shown, the angle of deflection a between each engagement surface and the first axis Y is approximately 25°, so each of the engagement surfaces 43, 53 engages the inner surface of the wall 1101 at an oblique angle of approximately (90−25)=65°. Of course, the angle of deflection may be varied by changing the relative dimensions and configuration of the tongue and the resilient strips.

Since the first or distal end portions of the retaining elements are advanced obliquely outwardly from the first axis Y into the space behind the wall 1101 as they travel through the slot, they do not need to be fully received in the space behind the slot before they are moved to the second configuration. Unlike prior art security attachments, their length and hence their footprint is therefore not limited by the length or width of the slot or by the depth of the space behind the slot. They are therefore able to extend further laterally away from the first axis Y to cover a larger area of the wall 1101 of the item than is possible with many prior art attachments, and hence provide a more secure attachment which progressively wedges itself into the aperture if axial tension is applied.

Moreover, the oblique engagement between the retaining elements and the item wall 1101 enables the attachment to securely engage in apertures having larger dimensions than the cross-sectional footprint of the tongue 20, and automatically centres the tongue in the aperture, while the spring loaded, retractable tongue 20 provides a sufficiently large range of axial adjustment to compensate automatically for the full range of variation encountered in practice in the thickness of the wall 1101 of the protected item. This ensures that the casing always firmly abuts the item wall in use, irrespective of the size of the slot or the thickness of the wall, solving the problem of looseness which might otherwise give an adverse impression of insecurity.

In tests on a total of 56 different types of security slots found on products from a wide range of manufacturers, the applicant has found that the novel security attachment provided a secure attachment in 54 out of the 56 security slots tested, while a commercially available prior art security attachment having a T-shaped cross-bar achieved a secure fixing in only 23 of the 56 slots.

Once the attachment is secured in the slot in the second configuration, the user then removes the key 11 from the lock barrel, and the tongue 20 is retracted automatically into the body 1 by the internal spring as shown in FIGS. 2A-2C so that the resilient cushion 8 abuts the outer face 1104 of the wall 1101 of the protected item as shown in FIG. 4. The resilient cushion extending from the body of the attachment (similarly to the rubber collar used in the prior art device discussed above) provides only a very small amount of resilient axial movement and therefore functions simply to cushion the attachment against the protected item.

In the illustrated embodiment, the casing 2 can be pulled away from the item wall 1101 against the restoring force of the internal spring 76 until it is restrained by abutment of the distal end portions of the retaining elements against the inner face 1103 of the item wall.

In a development, a non-return mechanism such as a ratchet or the like may be provided to permit axial retraction of the tongue but retain it in the retracted position while the attachment is in the second configuration until it is unlocked by the user. The attachment thus automatically clamps the wall 1101 of the item between the casing 2 and the projecting distal end portions of the retaining elements, so that the casing 2 cannot be pulled away from the item until the lock is released.

Referring to FIGS. 6A-6D, the base portion 21 of the tongue 20 is fixed axially in a split internal housing by means of its flange 31, which is captured in an annular groove 72 between the two halves 70, 71 of the housing. The lug 32 is received in a recess in one half 70 of the housing so that the tongue 20 is also fixed against rotation relative to the housing.

The lock barrel 10 is received in a lock body 75 which is also fixed axially and rotationally to the internal housing 70, 71. The lock body, housing and tongue 75, 70, 71, 21, 20 thus form a fixed assembly which is rotatably mounted in the outer casing 2 and biased away from the rotating plate 5, through which the tongue 20 extends, by the internal spring 76.

The anchor element 60 has a cylindrical waisted portion 63 at its proximal end, which terminates in an annular groove 64. A collar 85 is rotatably received on the waisted portion 63 and so that it abuts a shoulder 66 in one axial direction, and is retained axially in the other direction by a circlip 65 engaged in the groove 64.

The lock barrel 10 engages first abutment surfaces 81 on a cylindrical drive component 80 rotatably mounted in the internal housing 70, 71, so that the drive component 80 is rotated by the lock barrel 10 as the user rotates it by means of the key 11 relative to the lock body 75 and the tongue 20. The cylindrical drive component 80 also has second, axially elongate radial abutment surfaces 82 which slidingly engage corresponding radial abutment surfaces 86 on the collar 85, so that the collar 85 is axially slidable but rotationally fixed relative to the drive component 80.

Two oppositely directed studs 87 project radially outwardly from the collar 85 to engage a coarse internal helical thread 77 formed in the inner wall of the split internal housing 70, 71. As the collar 85 is rotated by the drive component 80, it also rotates about the anchor element 60, and the anchor element 60 and collar 85 move axially together as the collar 85 is urged axially along the internal housing 70, 71 by engagement of the studs 87 in the thread 77.

The attachment is thus operable by the user by rotating the key 11 in the lock barrel. By rotating the key in a first direction, the anchor element 60 and retaining elements 40, 50 are urged axially outwardly relative to the tongue so that the distal end portions 42, 52 extend laterally outwardly at an oblique angle in the second configuration. By rotating the key in the opposite direction, the anchor element 60 and retaining elements 40, 50 are retracted so that the attachment is returned to the first configuration.

Referring to FIGS. 9A-11B, a second security attachment is similar to the first, except that the first or distal end portion 102, 112 of each retaining element 100, 110 has a thickened region 104, 114 which engages the wedge shaped distal end portion of the tongue. Each retaining element comprises a generally straight, flat strip of flexible, non-compressible material, preferably a metal, e.g. spring steel, having a straight outer wall 105, 115 whose distal end portion defines the engagement surface 103, 113, and an inner wall 106, 116 which diverges from the outer wall at the distal end of the strip to form an angled portion 107, 117 and a straight portion 108, 118 at its extreme end.

In the rest condition before assembly of the attachment, each of the engagement surfaces 103, 113 is therefore aligned with the second or proximal portion of the respective outer wall 105, 115 as shown in FIGS. 11A-11B. Each of the engagement surfaces is generally flat, and may be ribbed or serrated to positively engage the periphery of the slot in use.

In the retracted position of the strips, the tip of the wedge in the tongue 20 is positioned between the straight portions 108, 118 so that it exerts an outward, expanding force D2 which forces the distal end portions 102, 112 slightly apart into the stressed position shown in FIG. 9B. At the same time, the strips are held parallel for the remainder of their length with their inner walls 106, 116 pressed together by the inward, restraining force D1 provided by the internal walls of the cavity in the tongue 20.

In the extended position of the strips, the thickened sections 104, 114 are forced past the wedge into the stressed position illustrated in FIG. 10B so that the engagement surfaces 103, 113 engage the periphery of the security slot as described above with reference to the first embodiment.

In summary, a preferred embodiment provides a security attachment for engagement in a security slot in the casing of a laptop computer or the like, having a body with an integral, rotatable lock and a projecting tongue which is axially retractable into a flat sided, rotatable outer casing. A pair of spring steel strips are slidably mounted in an elongate cavity in the tongue. The tongue is inserted into the security slot by pushing the lock into the casing, and then locked in place by rotating the lock so as to advance the strips axially through the security slot within the tongue. The distal ends of the strips are deflected progressively outwardly via lateral apertures at the distal end of the tongue by sliding engagement with a wedge formed at the distal end of the tongue so that they engage the laptop casing at the periphery of the aperture at an oblique angle.

In alternative embodiments, only one retaining element might be used, in which case the tongue may provide a hook or flange or the like which engages one side of the security aperture while the retaining element engages the other. The or each retaining element could also be articulated rather than being a unitary resilient element, so that its distal end portion is connected to its proximal portion by a rotatable joint. The attachment may also be configured from the first configuration to the second configuration, for example by axial pressure, rather than by rotation of a key.

In yet further embodiments, the engagement surface of the or each retaining element may comprise a ribbed, knurled, serrated or coated outer surface which engages the edge of the security slot, or may be formed by an outwardly extending flange, protrusion or thickened region, e.g. a triangular or wedge shaped, thickened region of a distal end of the retaining element, which may be engaged flat against the wall of the protected item or alternatively at an oblique angle.

Rather than a steel cable, the attachment may provide an alarm which is triggered by removal or movement, or any other security means, or for example may simply provide a ring or other anchor point to which a cable or any other security device may be attached. In less preferred embodiments, the attachment need not include a lock, and may be secured for example by passing a cable or a padlock or the like through cooperating parts of the body. Rather than a key operated lock, a combination lock or an electronic sensing system may be provided.

The retaining element or elements may be mounted on or guided by the outer surface of the tongue rather than slidably received within it. The tongue and retaining element or elements may be configured for insertion into circular or non-circular security apertures of various different shapes and sizes, and may be rotatably or non-rotatably received in the aperture. The retaining elements need not necessarily slide relative to the tongue, and the attachment may be operable by means other than sliding displacement of the retaining elements, including for example by means of rotating cam surfaces or torsion of the retaining element or elements. The retaining element or elements may also be configured to extend obliquely towards the inner face of the wall of the item, rather than obliquely away from it as shown in the illustrated embodiments.

The axially retractable tongue and the flat sided, rotatable casing may advantageously be incorporated into security attachments of many different types, and are not limited to use with the novel retaining elements disclosed herein. This solves the problem of looseness referred to above by automatically adapting the attachment to engage walls of different thicknesses, and/or provides greater flexibility for the manufacturer to adapt the outer casing to respond to changing consumer demand, for example, by printing or moulding the flat sides in various colours or with variable indicia.

For example, in alternative embodiments the retractable tongue may comprise a rotatable spindle, and the engagement surface may be formed on a T-shaped cross bar arranged at a distal end of the spindle as known in the art. The locking mechanism is arranged to be axially moveable within the outer casing so that the spindle together with any fixed pins arranged alongside it are retractable for part of their length, for example, by means of an internal compression spring arranged between an internal end surface of the casing and an internal abutment surface of the lock. A rubber cushion may be arranged around the tongue. Similarly, a conventional security attachment (with the tongue formed as a T-bar spindle, a flanged bar, a pair of barbed prongs urged apart by a wedge, or any other conventional arrangement) may be provided with a rotating outer casing comprising a plurality of flat sides, most preferably by mounting the locking mechanism within an axially elongated chamber containing an internal bias spring so that the tongue is also retractable into the outer casing.

The present invention in its various aspects is limited only by the claims, and is intended to embrace these and many other adaptations as will be evident to those skilled in the art.

1-41. (canceled)

42. A security attachment adapted to engage in a security aperture provided in a wall of an item, the aperture extending through the wall along a first axis generally normal to the wall and being defined by a periphery, the attachment comprising:
a body;
a tongue extending from the body, the tongue being adapted for insertion into the aperture;
at least one retaining element cooperating with the tongue, the retaining element having a first portion defining an engagement surface;
the attachment being operable by a user to configure the attachment between a first configuration in which the tongue can be removed from the aperture, and a second configuration in which the engagement surface extends laterally beyond the periphery of the aperture behind the wall of the item so as to engage the wall and so retain the tongue and the retaining element securely in the aperture;
wherein the attachment is configurable from the first configuration to the second configuration by deflection of the first portion of the retaining element outwardly away from the tongue such that the engagement surface engages the wall of the item at an oblique angle.

43. A security attachment according to claim 42, wherein the retaining element comprises an elongate strip of flexible, non-compressible material having a second portion integral with the first portion, and wherein the first portion is bent resiliently outwardly away from the tongue in the second configuration.

44. A security attachment according to claim 43, wherein the engagement surface comprises a generally flat outer surface of the retaining element which is generally aligned with the second portion in a rest condition of the retaining element.

45. A security attachment according to claim 42, wherein the attachment is configurable from the first configuration to the second configuration by a sliding translation of the retaining element relative to the tongue, and the first portion of the retaining element is deflected outwardly away from the tongue as the retaining element is advanced through the aperture in a direction generally in alignment with the first axis.

46. A security attachment according to claim 42, wherein in the first configuration, the tongue and the first portion of the retaining element can be simultaneously inserted together into the aperture and removed together from the aperture.

47. A security attachment according to claim 43, wherein the second portion of the retaining element is retained generally in alignment with the first axis in the second configuration.

48. A security attachment according to claim 42, wherein the attachment includes a pair of said retaining elements whose respective first portions are urged apart in the second configuration.

49. A security attachment according to claim 42, wherein the body includes a lock, and wherein the attachment is configured from the first configuration to the second configuration by operation of the lock.

50. A security attachment according to claim 42, wherein the body includes an outer casing, and wherein the tongue is axially retractable into the outer casing.

51. A security attachment adapted to engage in a security aperture provided in a wall of an item, the aperture extending through the wall along a first axis generally normal to the wall and being defined by a periphery, the attachment comprising:
a body;
a tongue extending from the body, the tongue being adapted for insertion into the aperture; and
at least one retaining element cooperating with the tongue, the retaining element having a first portion integral with a second portion, the first portion defining an engagement surface;
the attachment being operable by a user to configure the attachment between a first configuration in which the tongue can be removed from the aperture, and a second configuration in which the engagement surface extends laterally beyond the periphery of the aperture behind the wall of the item so as to engage the wall and so retain the tongue and the retaining element securely in the aperture;
wherein the attachment is configurable from the first configuration to the second configuration by a sliding translation of the retaining element relative to the tongue;
wherein the retaining element is made from flexible, non-compressible material;
wherein the tongue defines a bend zone; and
wherein the first portion of the retaining element is bent progressively resiliently outwardly away from the tongue by sliding abutment with the bend zone as it passes in translation through the bend zone.

52. A security attachment according to claim 51, wherein the engagement surface comprises a generally flat outer surface of the retaining element which is generally aligned with the second portion in a rest condition of the retaining element.

53. A security attachment according to claim 51, wherein in the first configuration, the tongue and the first portion of the retaining element can be simultaneously inserted together into the aperture and removed together from the aperture.

54. A security attachment according to claim 51 wherein the second portion of the retaining element is retained generally in alignment with the first axis in the second configuration.

55. A security attachment according to claim 51, wherein the attachment includes a pair of said retaining elements whose respective first portions are urged apart in the second configuration.

56. A security attachment according to claim 55, wherein the first portions of the retaining elements are urged apart by sliding abutment with a wedge shaped distal end portion of the tongue.

57. A security attachment according to claim 56, wherein the first portion of each retaining element includes a thickened region which engages the wedge shaped distal end portion of the tongue.

58. A security attachment according to claim 55, wherein the tongue defines an elongate cavity terminating in a pair of oppositely directed apertures, and wherein the retaining elements are slidably received in the cavity such that their respective first portions extend from the apertures in the second configuration.

59. A security attachment according to claim 51, wherein the body includes a lock, and wherein the attachment is configured from the first configuration to the second configuration by operation of the lock.

60. A method of engaging a security aperture provided in a wall of an item, the aperture extending through the wall along a first axis generally normal to the wall and being defined by a periphery, the method comprising:
(i) providing a security attachment, the attachment including a body, a tongue extending from the body, and at least one retaining element cooperating with the tongue, the retaining element being made from a flexible, non-compressible material and having a first portion defining an engagement surface;
(ii) inserting the tongue into the aperture; and then
(iii) advancing the retaining element slidingly through the aperture relative to the tongue, and simultaneously
(iv) deflecting the first portion of the retaining element resiliently outwardly away from the first axis so as to extend the engagement surface laterally beyond the periphery of the aperture behind the wall of the item and so retain the tongue and the retaining element securely in the aperture.

61. A method according to claim 60, wherein the attachment comprises two said retaining elements, and wherein the respective first portions of the retaining elements are simultaneously deflected resiliently outwardly in opposite directions.
